(19) United States
(12) Patent Application Publication
(10) Pub. No.: US 2010/0119295 A1
(43) Pub. Date: May 13, 2010

(54) Snap-Lock Engagement Pulley

(75) Inventors: David T. Renke, Macomb, MI (US); Gavin J. Brownlie, JR., Sterling Heights, MI (US); Cheryl L. Farner, Oxford, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/268,479

(22) Filed: Nov. 11, 2008

(51) Int. Cl. F16D 1/00; F16H 7/20

(52) U.S. Cl. 403/14; 474/198

(57) ABSTRACT

A pulley having an axis of rotation includes a flexible projection portion configured for rotatable snap-lock engagement with an object having an aperture.

### TECHNICAL FIELD

The invention relates to a pulley for rotatable engagement with an object.

### BACKGROUND OF THE INVENTION

A pulley is a type of wheel configured for changing direction of an applied force, transmitting rotational motion, or realizing a mechanical advantage. A pulley typically conveys force and motion transmitted to it via a drive element, such as a belt.

In order to change direction of an applied force or to realize a mechanical advantage, pulleys are often anchored in place, i.e. attached to objects such as mounting brackets or structural panels. Such attachment is typically accomplished via conventional assembly techniques, which generally include use of common fasteners, such as screws or rivets.

Often, however, pulley attachment via common fasteners requires use of a lubricating agent and/or a bearing to reduce the pulley's operating friction and to extend its service life. Consequently, use of such fasteners may add time to the assembly process, as well as to the cost and weight of the finished product.

### SUMMARY OF THE INVENTION

A wheel having an axis of rotation and a flexible projection portion is provided. The flexible projection portion is configured for rotatable snap-lock engagement with an object that includes an aperture of a specified diameter.

The wheel may also have a first side face orthogonal to the axis of rotation, a second side face parallel to the first side face, and an annular portion arranged between the first face and the second face. Additionally, the flexible projection portion may include multiple flexible projections arranged concentrically on the first side face on a pitch diameter relative to the axis of rotation.

The wheel may further include engagement portions arranged on the flexible projections orthogonal to the axis of rotation. Such engagement portions would have an outer diameter that is greater than the pitch diameter and would be arranged to spring back for snap-lock engagement when pushed through the aperture, wherein the aperture's diameter is smaller than the outer diameter of the engagement portions. The engagement portions may further include lead-in chamfers for reducing a force required to push the engagement portions through the aperture.

The wheel may be configured as a unitary structure formed from plastic. The wheel may also be configured to operate as a pulley by including a groove on the annular portion's perimeter for receiving a drive element.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional fragmentary side view of a pulley snap-lock engaged with an object;

FIG. 2 is a schematic cross-sectional fragmentary side view of the pulley shown in FIG. 1 in the process of being engaged with the object;

FIG. 3 is a schematic side view of the pulley shown in FIGS. 1 and 2 snap-lock engaged with the object;

FIG. 4 is a schematic isometric perspective view of the pulley shown in FIG. 3 snap-lock engaged with the object shown in a fragmentary view;

FIG. 5 is a flow chart illustrating a method of assembling a pulley with an object.

### DESCRIPTION OF THE PREFERRED EMBODIMENTS

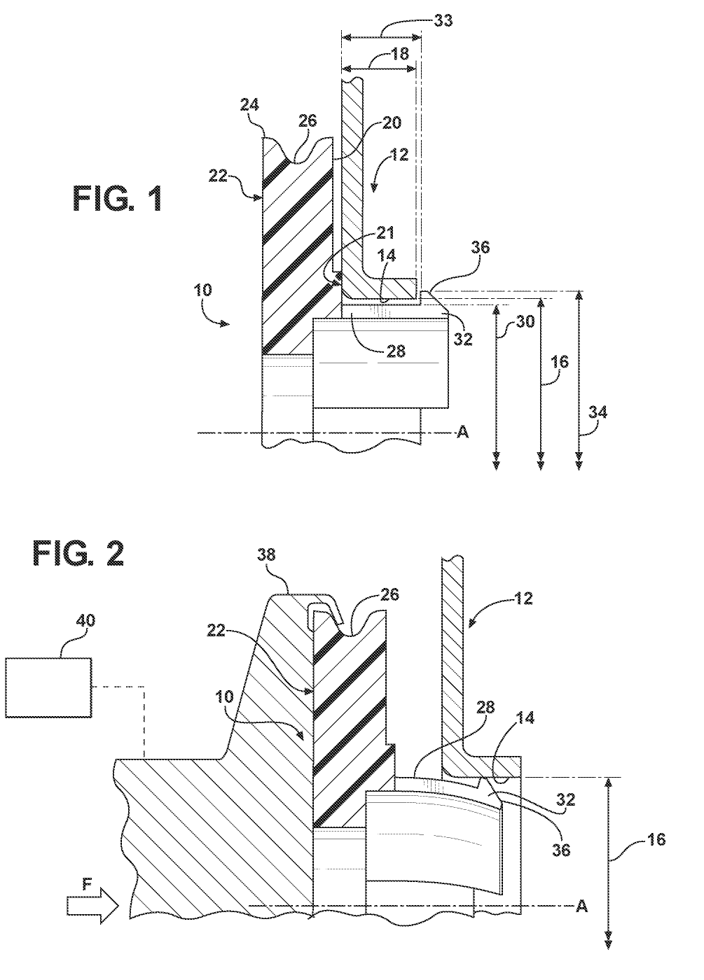

Referring to the drawings, wherein like reference numbers refer to like components, FIG. 1 shows a cross-sectional view of a pulley 10 snap-lock engaged with an object 12, such as, for example, a window regulator mechanism for a vehicle. The pulley 10 is a type of a wheel configured for rotation around an axis A for changing direction of an applied force, transmitting rotational motion, or realizing a mechanical advantage. The object 12 has an aperture 14 with a diameter 16. The object 12 has a flange thickness 18 at the aperture 14. The object 12 may be a mounting bracket or a structural panel for supporting the pulley 10 during operation.

The pulley 10 has a first side face 20 which is configured orthogonally with respect to the axis A. The first side face 20 has a reaction surface 21, similarly orthogonal to the axis A, and configured to contact the object 12 during the pulley's assembly and engagement with the object 12 The pulley 10 also has a second side face 22 which is configured parallel to the first side face 20. An annular portion 24 bridges the first side face 20 and the second side face 22 on the pulley's perimeter. Annular portion 24 includes a groove 26 for receiving a drive element (not shown), such as a belt.

The pulley 10 includes flexible projections 28 arranged on the first side face 20 on a pitch diameter 30 concentrically with respect to the axis A. The flexible projections 28 include engagement portions 32. Engagement portions 32 have an outer diameter 34 that is greater than the pitch diameter 30. The flexible projections 28 have a length 33 between the reaction face 21 and the engagement portions 32. Length 33 is configured to be greater than the flange thickness 18 of the object in order to facilitate rotational movement of the pulley 10 relative to the object 12. The flexible projections 28 are arranged to function as a bearing surface, to thereby facilitate rotational engagement of the pulley 10 with the object 12 after the assembly is complete.

The engagement portions 32 include a lead-in chamfer 36. The lead-in chamfer 36 is incorporated into the engagement portions for reducing insertion force F required to push the engagement portions 32 through the aperture 14 in the object 12. The diameter 16 of the aperture is smaller than the outer diameter 34 of the engagement portions 32 in order to facilitate rotational movement of the pulley 10 relative to the object 12.

As shown in FIG. 2, the engagement portions 32 flex toward the axis A during assembly of the pulley 10 into the object 12. The engagement portions' outer diameter 34 contracts to diameter 16 under the influence of the insertion force F, thereby permitting the engagement portions 32 to pass through the aperture 14. Following the engagement portions 32 passing through the aperture 14, the engagement portions spring back to their original shape, where their outer diameter 34 is restored. When the engagement portions 32 spring back to restore the outer diameter 34 behind the flange thickness 18, the snap-lock engagement of the pulley 10 with the object 12 is complete (as shown in FIG. 2).

The insertion force F may be provided by an assembly apparatus shown in part by an installation fixture 38. The fixture 38 may be used to align the pulley, and be configured to apply the force F on the second side face 22 and/or on the groove 26 of the pulley 10. A load cell (not shown) may be incorporated into the installation fixture to sense the insertion force F. Assembly of the pulley 10 into the object 12 is controlled by a controller 40 in electronic communication with the assembly apparatus, in response to the force F sensed by the load cell, as shown in FIG. 2.

The controller 40 is programmed with an algorithm to control the pulley 10 assembly based on a predicted fluctuation of insertion force F during assembly. In general, the force F can be expected to vary between an initial magnitude corresponding to the engagement of the engagement portions 32 with object 12 at aperture 14, a force drop representing spring back of the flexible projections 28 during their snap-lock engagement with the object 12, and a sharp increase representing contact between the reaction surface 21 and the object 12. The expected force fluctuation may be established empirically during design and development of the pulley and its assembly operation.

The pulley 10 as described may comprise a unitary structure formed from an engineering plastic. Such construction may utilize any of the appropriate materials known by those skilled in the art, formulated to reduce the pulley's rotating friction at the reaction face 21 and at the flexible projections 28. The utilization of such materials for construction of pulley 10 is therefore likely to enhance the pulley's performance and extend its service life.

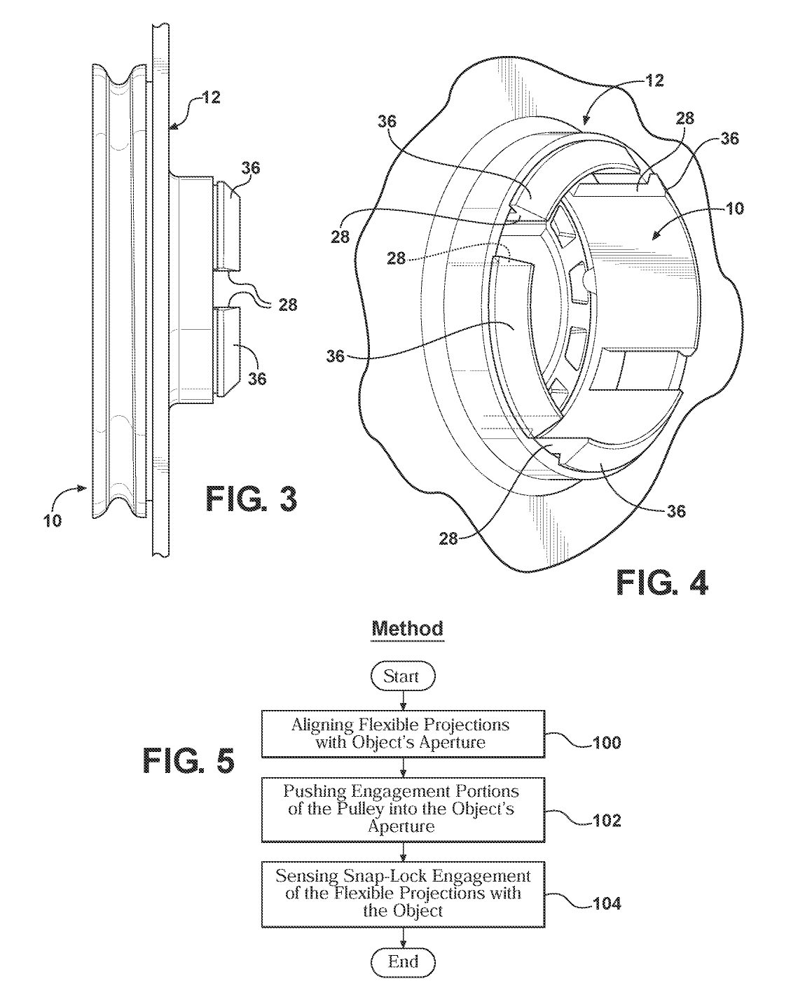

A method of assembling a pulley with an object is shown in FIG. 5 and is described below with respect to the pulley 10 of FIGS. 1-4. In block 100 the method includes aligning flexible projections 28 arranged on the pulley with the aperture 14 having a diameter that is smaller than the outer diameter of the engagement portions 32. The pulley's flexible projections 28 are arranged on a pitch diameter 30 concentric with the pulley's axis of rotation A, and configured with engagement portions 32 having an outer diameter 34 that is greater than the pitch diameter 30. In block 102 the engagement portions 32 are pushed into the aperture 14, and snap-lock engagement of the flexible projections with the object is sensed in block 104.

The sensing of the flexible projections' spring back for snap-lock engagement may be accomplished via recognizing an increase in load representing engagement of the engagement portions 32 with the object 12. Sensing also includes recognizing a load drop representing spring back of the flexible projections 28 signifying snap-lock engagement of the pulley with the object. Sensing may additionally include recognizing a load increase representing a hard stop, i.e. contact of the pulley's reaction surface 21 with the object 12. The load increase representing a hard stop is more abrupt and greater than the load increase representing engagement of the engagement portions 32 with the object. Hence, pushing the engagement portions into the aperture may be performed until the hard stop is sensed.

According to the method, aligning, pushing and sensing may be performed automatically by the assembly apparatus, shown in part by the installation fixture 38 in FIG. 2. The assembly apparatus may also employ a load cell (not shown), and an electronic controller 40 programmed with an algorithm and in electronic communication with the load cell, as described above in connection with FIG. 2. The installation and alignment of the pulley may therefore be accomplished by the installation fixture 38. The sensing may be performed by the load cell, which may be incorporated into the installation fixture 38. The control of the assembly operation may be performed by the electronic controller 40 in response to the load sensed by the load cell. In the alternative, the aligning, pushing and sensing functions may be performed manually by an operator, i.e. a human being (not shown).

The snap-lock engagement pulley 10 provides a cost efficient, mass efficient, and assembly labor efficient pulley design, by reason of the pulley attachment being achieved without a separate fastener, such as a bolt, a screw, or a rivet.

While the best modes for carrying out the invention have been described in detail, those familiar with the art to which this invention relates will recognize various alternative designs and embodiments for practicing the invention within the scope of the appended claims.

1. A pulley having an axis of rotation for rotatable engagement with an object that includes an aperture having a diameter, the pulley comprising a flexible projection portion arranged surrounding the axis of rotation and configured for snap-lock engagement with the object;
wherein the flexible projection portion is arranged as a bearing surface to thereby facilitate the rotatable engagement with the object.

2. (canceled)

3. The pulley of claim 1, further comprising a first side face orthogonal to the axis of rotation, a second side face parallel to the first side face, an annular portion arranged between the first face and the second face, wherein the flexible projection portion includes multiple flexible projections arranged on the first side face on a pitch diameter concentric with the axis of rotation.

4. The pulley of claim 3, further comprising engagement portions arranged on the flexible projections substantially orthogonal to the axis of rotation, the engagement portions having an outer diameter that is greater than the pitch diameter and arranged to spring back for snap-lock engagement when pushed through the aperture, wherein the diameter of the aperture is smaller than the outer diameter of the engagement portions.

5. The pulley of claim 4, wherein the engagement portions further comprise lead-in chamfers for reducing a force required to push the engagement portions through the aperture.

6. The pulley of claim 1, further comprising a groove on a perimeter of the annular portion for receiving a drive element.

7. The pulley of claim 1, wherein the pulley is a unitary structure formed from plastic.

8. A pulley having an axis of rotation for rotatable engagement with an object that includes an aperture having a diameter, the pulley comprising:
a first side face orthogonal to the axis of rotation;
a second side face parallel to the first side face;
an annular portion having a perimeter arranged between the first side face and the second side face;
a groove arranged on the perimeter of the annular portion for receiving a drive element;
flexible projections arranged on the first side face on a pitch diameter concentric with the axis of rotation; and
engagement portions arranged on the flexible projections orthogonal to the axis of rotation, the engagement portions having an outer diameter that is greater than the pitch diameter and arranged to spring back for snap-lock engagement when pushed through the aperture, wherein the diameter of the aperture is smaller than the outer diameter of the engagement portions;
wherein the pulley is rotatably engaged with the aperture when the engagement portions are pushed through the aperture, and the flexible projections are arranged as a bearing surface to thereby facilitate the rotatable engagement with the object.

9. (canceled)

10. The pulley of claim 8, wherein the engagement portions further comprise lead-in chamfers for reducing a force required to push the engagement portions through the aperture.

11. The pulley of claim 8, wherein the pulley is a unitary structure formed from plastic.

12. A method of assembling a pulley having an axis of rotation with an object that includes an aperture, the method comprising:
aligning flexible projections arranged on the pulley with the aperture, wherein the flexible projections are arranged on a pitch diameter concentric with the axis of rotation and configured with engagement portions having an outer diameter that is greater than the pitch diameter, and wherein the aperture has a diameter that is smaller than the outer diameter of the engagement portions;
pushing the engagement portions into the aperture; and
sensing snap-lock engagement of the flexible projections with the object.

13. The method of claim 12, wherein said sensing snap-lock engagement comprises recognizing a load increase representing engagement of the engagement portions with the object followed by recognizing a load drop representing snap-back engagement of the flexible projections.

14. The method of claim 12, wherein said sensing further comprises recognizing a load increase representing a hard stop, wherein the load increase representing a hard stop is more abrupt and greater than the load increase representing engagement of the engagement portions with the object, and wherein pushing is performed until a hard stop is sensed.

15. The method of claim 12, wherein said aligning, said pushing and said sensing are performed automatically by an assembly apparatus.

16. The method of claim 12, wherein said aligning, said pushing and said sensing are performed manually by an operator.
